(19) United States
(12) Patent Application Publication
(10) Pub. No.: US 2020/0258212 A1
(43) Pub. Date: Aug. 13, 2020

(54) ERROR REDUCTION IN IMAGES WHICH WERE GENERATED WITH CHARGED PARTICLES AND WITH THE AID OF MACHINE-LEARNING-BASED METHODS

(71) Applicant: Carl Zeiss SMT GmbH, Oberkochen (DE)

(72) Inventors: Jens Timo Neumann, Aalen (DE); Thomas Korb, Schwaebisch Gmuend (DE); Abhilash Srikantha, Neu-Ulm (DE); Christian Wojek, Aalen (DE)

(21) Appl. No.: 16/786,307

(22) Filed: Feb. 10, 2020

(30) Foreign Application Priority Data
Feb. 12, 2019 (DE) 102019103503.1

(51) Int. Cl. G06T 7/00; G06T 5/00; G06T 7/62; G01B 15/04; G06N 20/00; G06N 7/00

(52) U.S. Cl. CPC G06T 7/0004; G06T 5/002; G06T 7/62; G01B 15/04; G06T 2207/10061; G06N 7/005; G06T 2207/30148; G06T 2207/20081; G06N 20/00

(57) ABSTRACT

Methods for determining one or more quality or size parameters of a structure in a semiconductor product, on the basis of an image of the semiconductor product which was generated with the aid of charged particles which have been radiated onto the semiconductor product, include: providing the image of the semiconductor product; applying the provided image to a machine-learning-based method such as, e.g., an artificial neural network which has been trained with training images of semiconductor products and which is configured to generate an output parameter from the provided image; and determining the size parameter of the structure on the basis of the output parameter.

### CROSS-REFERENCE TO RELATED APPLICATION

This application claims benefit under 35 U.S.C. § 119 to German Application No. 10 2019 103 503.1, filed Feb. 12, 2019. The content of this application is hereby incorporated by reference in its entirety.

### FIELD

The present disclosure relates to a method for determining a quality or size parameter of a structure in a semiconductor product, on the basis of an image of the semiconductor product which was generated with the aid of charged particles which have been radiated onto the semiconductor product. In addition, provision is made of the device that is configured to determine the quality or size parameter or the structure.

### BACKGROUND

Images of semiconductor products which were generated with charged particles, such as SEM (Scanning Electron Microscope) images, for example, are usually beset by errors or noise and exhibit an uncorrelated fluctuation of the pixel intensity in addition to the actual pixel intensity distribution caused by the semiconductor product itself. A principal cause of this image noise in the case of an SEM image is the noise of the primary electrons, that is to say the fluctuation of the number of primary electrons per pixel. The average number of primary electrons per pixel is usually limited to a few 100 electrons on account of restrictions of the particle beam, or in order to prevent the sample from being charged. Since the number of primary electrons follows Poisson statistics, this relatively low average number of electrons per pixel results in a relatively wide standard deviation of the actual number of primary electrons per pixel. Further causes of the image errors or the image noise are based, inter alia, on the fact that backscattered or secondary electrons are detected, which in turn follow their own statistics. Furthermore, it is possible for the noise to be amplified if the raw detector signal is amplified. Besides the image noise, other image errors can also arise as a result of the generation of the image with charged particles, e.g. as a result of charging of the sample, which can then lead to the deflection of the primary electron beam and thus to local distortions of the image.

These image errors make an accurate image analysis more difficult. In this regard, by way of example, it is sometimes not possible to determine a line width in a structure of the semiconductor product using a simple application of an intensity threshold that separates structures in the image from the image background in order subsequently to determine the distance between the edges. The randomly distributed intensity fluctuations that arise in any pixel as a result of the image noise can lead to results that cannot be evaluated. If only an average line width is intended to be determined, then these cases can be resolved, for example using measurements along a plurality of lines and averaging. Furthermore, it is possible to filter the image in order to reduce the errors or the noise, either with the aid of a simple convolution with a Gaussian probability distribution or with other suitable filter techniques. In any case, the image information spreads over the neighbouring pixels. Extensive information of the semiconductor product is thus maintained in the image, while detail information is lost on account of the pixel noise. This means that detail information can be lost as a result of the filtering or averaging.

As long as only average values are of interest, this does not matter. In the case of semiconductor products, however, it is important to obtain accurate information about individual variables, for example the line width or the line roughness of conductor tracks. These variables are important for determining the resistance or in order to avoid short circuits. Furthermore, in the case of semiconductor structures, a plurality of layers are positioned one above another and the accurate positioning with respect to one another, in particular of the edges, is of importance for the correct functioning of the finished semiconductor product. By way of example, the roughness of a line, on account of the Poisson statistics of the photons in the lithographic exposure or on account of stochastic processes in the photoresist, is an important parameter for qualifying the materials and processes used. This desired information is then concealed by image errors such as e.g. the image noise. The above-described methods such as averagings, convolutions or filters are not suitable for separating the image noise from the variable that is actually to be determined. Consequently, there is no satisfactory possibility for accurately determining individual size parameters in a structure of a semiconductor product.

In the case of error-containing SEM images, in at least some known approaches, prior knowledge of an expert is involved, for example knowledge of how the structure of the semiconductor product is formed, or the expert knowledge is used for the correct choice of the filters, etc. The parameters used during the processing, such as the size of the conduction channel, limit values for intensities, filters, edge extraction, are provided by experts and adapted such that the estimation of the size parameters sought, such as e.g. the edge roughness, is possible optimally.

Such manual processing sequences cannot be used on a grand scale since different parameters may be involved for each example. Furthermore, the optimization of the parameters is difficult since it is not easy to ascertain how the variation of the individual parameters ultimately influences the accuracy in the determination of the size parameter. Overall, therefore, in at least certain known approaches, a great deal of expertise is used in order to obtain spatially resolved information about variables of structural components of the semiconductor product from an error-containing SEM image.

### SUMMARY

The present disclosure seeks to simplify and to improve the determination of a quality or size parameter of a structure in a semiconductor product in an image which contains errors as a result of the production process.

In accordance with a first aspect, provision is made of a method for determining a size parameter of a structure in a semiconductor product, wherein the determination is effected on the basis of an image of the semiconductor product which was generated with the aid of charged particles which have been radiated onto the semiconductor product. The method includes the step of providing the image of the semiconductor product. Furthermore, the provided image is applied to a machine-learning-based method which has been trained with training images of semiconductor products and which is configured to generate an output parameter from the provided image. Furthermore, the size parameter of the structure is generated on the basis of the output parameter.

The machine-learning-based method can be a trained artificial neural network or a random forest method, as an example of a non-linear method. Methods such as ridge regression, support vector machine or Gaussian methods can be used as linear method.

In the present case of images of semiconductor products, an artificial neural network or any other machine-learning-based method which has been trained with training images of semiconductor products can help to reduce the issues mentioned above and can help to determine a size parameter of a structure in a semiconductor product.

The size parameter can be for example the roughness of an edge in the semiconductor structure, the width of an element such as a conductor track in the semiconductor structure, a diameter of an opening in the semiconductor structure or the LCDU (Local Critical Dimension Uniformity) variable. A quality parameter can be for example a number or density of defects such as e.g. short circuits, interrupted conductor tracks, missing or not cleanly separated contacts (“vias”).

The artificial neural network can be embodied here in such a way that it determines the size parameter directly from the provided image, wherein in this example the output parameter determined by the neural network is the size parameter of the semiconductor structure itself. In this embodiment, virtually no expert knowledge is used for determining the size parameter since the artificial neural network has been trained in such a way that the size parameter can be determined directly from the provided image by the network.

Furthermore, it is possible for the artificial neural network to be configured to determine from the provided image the semiconductor structure itself, which is substantially independent of the charged particles. The size parameter can then be calculated on the basis of the semiconductor structure determined. In this case, the artificial neural network provides information about the semiconductor structure, which is substantially independent of the recording technique and the image used. If the structure is known per se, then the size of individual structures of the semiconductor structure can be determined.

Furthermore, it is possible for the artificial neural network to be configured to determine from the provided image an error-reduced image of the semiconductor structure, in which image the error components caused by the image creation with the aid of the charged particles are reduced by comparison with the provided image. The desired size parameter can then be calculated on the basis of the error-reduced image. In this example, the neural network is able to remove the error or noise components from the image. With the error-reduced image, the geometry information about the semiconductor product itself can be obtained more easily in order to determine the size parameter itself therefrom.

The provided image on the basis of which the artificial neural network generates the output parameter can be an error-containing image having the error components caused by the creation of the image by the charged particles being radiated in. In this case, for the neural network, use is made of the image such as was generated from the semiconductor product without methods being applied beforehand for reducing the errors or the noise.

Furthermore, it is possible for the provided image on the basis of which the artificial neural network determines the output parameter to be an error-reduced image of the semiconductor structure, in which image the error components caused by the image creation with the aid of the charged particles are reduced by comparison with an original image of the semiconductor structure which is an error-containing image having the error components caused by the creation of the image by the particles being radiated in. In this embodiment, an error-reduced image is generated by conventional known techniques, wherein the error-reduced image is then a starting point for the further determination of the size parameter.

The artificial neural network has been trained with training images. In this case, the training images can be actually recorded images of the semiconductor structure in which at least one of the following variables is known as desired output parameter of the artificial neural network in the untrained state: the magnitude of the size parameter, the semiconductor structure itself, an error-reduced image of the semiconductor structure, in which image the error components are reduced by comparison with an original image of the semiconductor structure having the error components caused by the creation of the image by the charged particles being radiated in. Such high-quality images which can be used as training images may have been created for example by methods in which the length of the irradiation with the particles or the duration of the image generation was unimportant. Such high-quality images can be generated e.g. by superimposition of a plurality of noisy individual images (“frame averaging”) or by slow scanning, optionally with a reduced current. Alternatively, size parameters for the training can also be obtained by other techniques, such as e.g. an atomic force microscope (AFM).

However, the training images can also be simulated images of the semiconductor structure in which at least some variables are known as desired output parameters of the artificial neural network in the untrained state. In the case of these training images, the output parameter is known as described above, such that the neural network can be trained for subsequent use for determining the size parameter in the case of images in which the size parameter is not yet known.

By way of example, a method known by the name Markov Chain Monte Carlo, MCMC, can be used in the determination of the simulated images.

In this case, training the artificial neural network in the untrained state can include solving a regression problem.

Furthermore, provision is made of an associated device configured to determine the size parameter as described above, wherein the device includes at least one processor and a memory, wherein the at least one processor is configured to load and to execute a program code from the memory and, on the basis of the execution of the program code, to carry out a method as described above or further below.

The features set out above and further features described below can be used not only in the corresponding combinations explicitly set out, but also in other combinations, unless explicitly indicated otherwise.

### BRIEF DESCRIPTION OF THE DRAWINGS

The disclosure is explained in greater detail below with reference to the accompanying drawings, in which:

FIG. 1 schematically shows various possibilities for determining a size parameter from an error-containing image of a semiconductor product with the aid of artificial neural networks;

FIG. 2 schematically shows a flow diagram with steps which can be carried out in the determination of the size parameter with the aid of the neural network;

FIG. 3 schematically shows how parameters can be determined with the aid of an error-containing image and differently trained neural networks, which parameters can subsequently be used for determining the size parameter of the semiconductor structure;

FIG. 4 schematically shows how, with different neural networks, from an error-reduced image of the semiconductor structure, either the semiconductor structure itself or directly the size parameter can be determined;

FIG. 5 schematically shows how, with the aid of a known semiconductor structure, the size parameter of the semiconductor structure can be determined using an artificial neural network;

FIG. 6 schematically shows a device configured to determine an output parameter with the use of a neural network, which output parameter is used in the determination of the size parameter of a semiconductor structure; and

FIG. 7 schematically shows how, with the aid of training images, an as yet untrained neural network can be trained in order that it is able to determine an output parameter which can be used to determine the size parameter of the semiconductor structure.

### DETAILED DESCRIPTION

The present disclosure is explained in greater detail below on the basis of preferred embodiments with reference to the drawings. In the figures, identical reference signs denote identical or similar elements. Furthermore, the figures are schematic illustrations of various embodiments of the disclosure. The elements illustrated in the figures are not necessarily illustrated in a manner true to scale. Rather, the elements illustrated are furthermore represented in such a way that their function and their purpose become comprehensible to the person skilled in the art. The connections between functional units or other elements as illustrated in the figures can also be implemented as indirect connection, wherein a connection can be wireless or wired. The functional units can be implemented as hardware, software, firmware, or as a combination thereof.

As is explained below, artificial neural networks or machine learning methods are used to determine a size parameter in a structure of a semiconductor product. The line roughness σ used below as an exemplary variable, but the method described is also applicable to other variables such as the so-called Local Critical Dimension Uniformity, LCDU, or the width of an element in the semiconductor structure, the diameter of an opening in the semiconductor structure, etc. SEM images are used as a basis, but images generated using charged particles other than electrons can also be used.

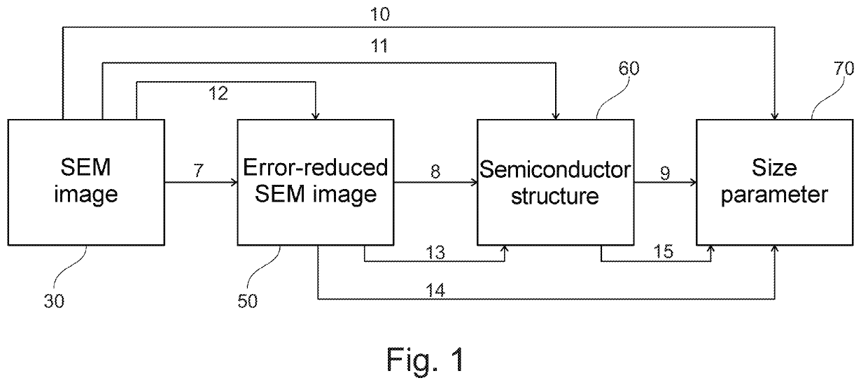

According to the disclosure, artificial neural networks are then used in order to avoid or to reduce the disadvantages described above. FIG. 1 schematically illustrates how specially trained neural networks can help to determine size parameters of a semiconductor structure such as the line roughness σ. Various variants are possible here. In a first method, illustrated by arrow 10, from an error-containing image 30 of the semiconductor structure, which image was created by the semiconductor structure being bombarded with charged particles, the size parameter 70 is determined directly by inputting the image in an artificial neural network trained specially for this purpose. In this case, the neural network is configured to select the desired size parameter directly from the input of the image 30, here an SEM image.

The training of the neural network configured in this way will be explained in greater detail later in association with FIG. 7.

A further possibility includes determining the semiconductor structure 60 directly from the SEM image with the aid of a specially trained neural network, in a method 11. In this method 11, the input data for the trained neural network include the error-containing or noisy SEM image and the output information of the neural network is directly the semiconductor structure, which is independent of the image recording technique used.

A further possibility includes a method 12, which generates a noise-reduced or an error-reduced image 50 from the noisy image 30 with the aid of a specially trained neural network.

In a further method 13, it is possible to use the noise-reduced image 50 as input data for a specially trained neural network, wherein the neural network outputs the semiconductor structure 60 as output parameter. A further possibility includes the method 14 for determining the size parameter 70 directly with the aid of the noise-reduced image 50 and a neural network trained specially for this purpose. Finally, in a method 15, with the input of the semiconductor structure 60, the size parameter 70 can be determined directly with the aid of a neural network trained specially for this purpose. Furthermore, known intermediate steps 7 to 9 are illustrated schematically, which may be involved if the method 10 is not used, rather the neural network is used to calculate the size parameter 70 not directly from the noisy image 30. The method 7 schematically symbolizes known possibilities as to how the noise-reduced image 50 can be generated from the noisy image 30, using known post-processing algorithms. Methods are likewise known as to how the semiconductor structure can be determined directly with the aid of the noise-reduced images 50 (method 8). Furthermore, it is known, according to the prior art, to determine the size parameter directly from the semiconductor structure by method 9. As described in the introduction, however, all these methods 7 to 9 have individual disadvantages and often involve expert knowledge, with the result that the determination of the size parameter can be improved and simplified with the aid of the methods 10 to 15, as explained below.

Specially trained neural networks or modules that have been trained using other machine learning methods are used for each of the methods 10 to 15. FIG. 7 schematically illustrates how an as yet untrained neural network 200 can generally be trained from training images 80 if the desired output parameter 85 is known for the training images 80. For the method 10, this means that the training images 80 are noisy SEM images from which the desired output parameter such as the size parameter itself, for example the line roughness, is known. In this training phase, the as yet untrained neural network 200 learns, with the aid of the input data and the wanted output data, how the weights of the individual neurons 210 change. This involves supervised learning rules since the correct output is predefined as desired output parameter and the weights are optimized thereto.

Referring to the method 10, this means that the training images are noisy images, or images beset by other errors, of the semiconductor structure, for which the line width is known as an example of the size parameter. This calculation can be modelled as an end-to-end classification or a regression problem. The model for this for the neural network is a mathematical function that maps the region of the noisy training image directly onto the size parameter. Other machine-learning-based methods can also be used instead of a neural network. Examples of linear methods are methods such as ridge regression, support vector machine or Gaussian processes. Examples of non-linear methods are, besides neural networks, e.g. random forest methods. The training data have input-output pairs, such as the training images 80 and the desired output parameter 85, on the basis of which the network model learns. The input-output pairs can be calculated by simulation, or noisy images are used, for which the wanted variable, the desired output parameter of the neural network, is known. Statistical models that input target variables and output wanted variables are used in the simulation. By way of example, it is possible to simulate a noisy image using physical descriptions of the edge roughness, the layout of the semiconductor structure, the etching process parameters and noise models. This forward simulation can be carried out for example using Markov Chain Monte Carlo, MCMC, methods as described for example in “Handbook of Markov Chain Monte Carlo” by Brooks, Steve et al. in Chapman and Hall/CRC 2011.

The advantage of this forward simulation is that the underlying parameters are well understood and can be suitably adapted. Typical MCMC simulations work with the following sequence:

1. A model of a physical sample, for example a CAD model, is generated with target variables such as, for example, an edge roughness, given material parameters and etching process variables. The current roughness variables or the associated spectrum are/is known for the training, which differs fundamentally from conventional methods, which make do with using measured images having a convolution of the current edge roughness and the noise or the image errors on account of the generation of the image by the charged particles.

2. A noise-reduced or error-reduced image is determined on the basis of the physical sample and the imaging generation modalities chosen.

3. The noisy image is generated with knowledge of the noise-reduced image and the stochastic consideration process on account of the image creation, for example with modelling of the noise that arises as a result of the changed image sensors, so-called shot noise.

In this training phase of the undertrained neural network 200, the neural network is used to generate the desired output parameters 85 continuously on the basis of the training images 80 provided. This can be formulated as a regression problem that can be solved by various models such as a weighted or unweighted method of least squares, ridge regression, support vector regression, Gaussian methods, random forest methods and convolved neural networks. The characteristic of the output parameter of the neural network determines the choice of network model. The output parameter can contain qualitative information, for example, such as low, medium or high roughness. However, it is also possible for the output parameter to yield directly a value for the output parameter, for example a roughness value or a roughness spectrum. Depending on the wanted output parameter, the model of the neural network is then chosen such that the wanted output parameter is generated. If exact values are wanted as output parameter, regression or structured regression models may be involved.

In summary, this means that a model is determined in the training phase proceeding from training images with known desired output parameters. The model can be determined using the following equation:

$$Model , θ = {arg min}_{\hat{θ}} ( L ( σ , {σ}_{est} \vert \hat{θ} ) \qquad ( 1 )$$

In this case, θ is the model, L is the separation between the roughness σ as known and the estimated roughness σₑₛₜ generated by the artificial neural network.

The reliability of the model generation can be increased with Bayesian modelling, for example Monte Carlo Dropout or Ensemble Learning.

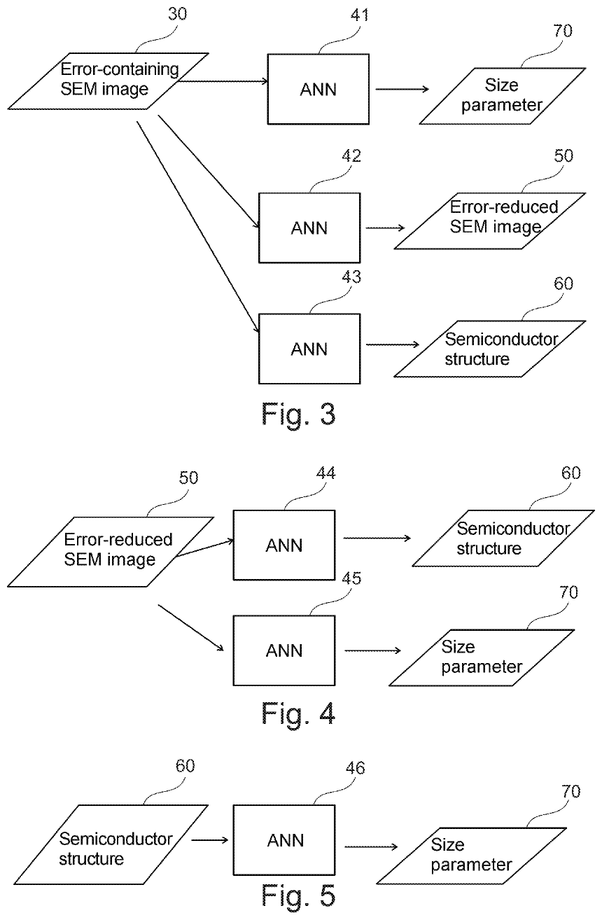

Referring to FIG. 3, this means that in this case the size parameter 70 can be determined directly from the noisy image of the semiconductor product 30 with the aid of an artificial neural network 41. In this example, the network 41 is configured to generate from the input parameter of the noisy image an output parameter that is directly the size parameter.

This complete modelling of the problem with the aid of a neural network in accordance with method 10 has the advantage that less expert knowledge is used for carrying out one of the intermediate steps. However, it is also possible to use a neural network for determining the semiconductor structure according to method 11. Referring to FIG. 3, this means that the input data of the trained neural network 43 include the noisy image, while the output information of the network 43 is the semiconductor structure itself. This also means, however, that training images containing noisy images are used during the training phase of the neural network 43, wherein the semiconductor structure was known for the noisy images and was fed as output information to the network to be trained.

The neural network 43 trained in this way is able to generate a representation such as, for example, the detected edges of the semiconductor structure, which is then used in order to determine the size parameter such as the line accuracy in the method 9. In this case, the neural network 43 can be configured to determine abstract physical properties such as, for example, a gradient of the light intensity, the edge position, the material roughness of the photoresist or the diffusion distance of the photo-etching liquid. As an alternative thereto, the neural network can be used to optimize the run times of an image analysis, e.g. by selecting specific regions (“regions of interest”) for an expert analysis on the basis of the results of the neural network, instead of subjecting the entire image to an analysis by an expert.

In this method 11, the neural network provides physical properties that can be used later by further modules in order directly to calculate the size parameter. These representations refer to representations of the output of step 1 of the MCMC as mentioned above. In such a case, the training images includes physical test semiconductor structures and the error-containing images which were obtained after the simulation was carried out. The network 43 can estimate intrinsic material properties, for example, in order to enable an expert analysis of diffusion metrics. Such methods can likewise enable the registration of the measured structure with respect to design data (CAD) or a 3D edge extraction. A semantic “labelling” can likewise be made possible, in which the individual pixels of the image are assigned to specific features or elements of the semiconductor structure (e.g. lines, trenches, vias).

Referring to FIG. 1, it is also possible to use a neural network to generate a noise-reduced image 50 from the noisy image 30, in a method 12. In this method, the neural network 42, as depicted in FIG. 3, is configured to generate a noise-reduced image from the noisy image. In this case, the network 42 has been trained with noisy images and known noise-reduced images. Besides suppressing image noise, such a method can also be employed in order to reduce other errors or irregularities which arise during image generation. This is possible with the use of deconvolution techniques, which can be parameter-driven, non-parameter-driven (anisotropic) or data-driven (random forest). One example of a parameter-driven deconvolution may be the reduction of “blur effects” that arise as a result of the finite point spread function (PSF) of the image recording technology. During the creation of the error-reduced images, it is also possible to use other methods, e.g. inter alia adaptation of the image statistics (contrast normalization, gamma correction) or the resolution. In the case of the images, compression techniques can be employed in the case of data-driven approaches. Likewise, regions not of interest can be masked out in the images with a masking.

As shown in FIG. 4, it is also possible to use neural networks in which noise-reduced images 50 are used as input data and either directly the semiconductor structure 60 (network 44) or directly the size parameter (network 45) is determined as output data. The network 44 is configured to determine the semiconductor structure directly from low-noise images, wherein the network 44 has been trained with training data in which the input data are the low-noise images, wherein the underlying semiconductor structure is known and is likewise made available to the network. The network 45 is likewise trained with input data including noise-reduced images, wherein the size parameter is known in each case for these input data and is used to train the network, in order to create the network 45.

Neural networks such as the network 46 can likewise be used to calculate the size parameter 70 using input data and knowledge of the semiconductor structure 60, as is illustrated by the network 46 in FIG. 5. In this case, the network 46 was trained with training data that contained semiconductor structures for which the size parameters were known.

The examples in FIGS. 3 to 5 used artificial neural networks which are each configured to determine specific output parameters from the input parameters after they have been trained accordingly. The networks 41 to 46 can also be replaced by modules that have been trained accordingly using other machine-learning-based methods mentioned above.

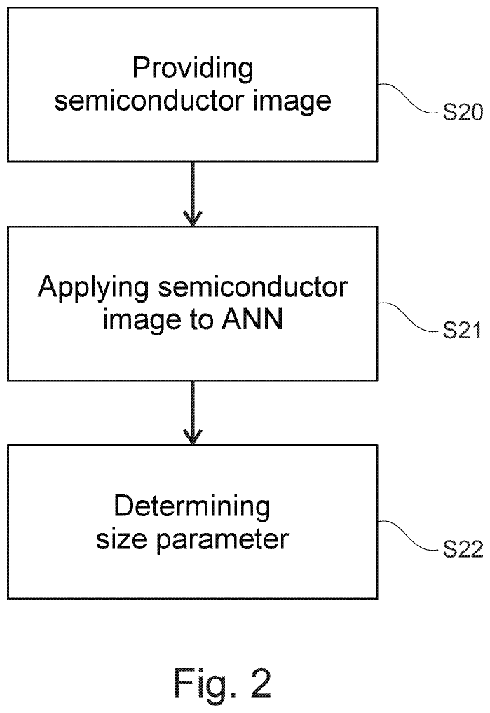

FIG. 2 summarizes some of the steps used to determine a size parameter of the semiconductor product from a semiconductor image provided. In a step S20, the image of the semiconductor product is provided. As was explained in association with FIGS. 3 and 4, the provided image can be the error-containing image or the already error-reduced image, in which the errors arising on account of the technique of image generation have been minimized. Afterwards, in a step S21, the semiconductor image is applied to the respective artificial neural network, namely one of the networks 41 to 45, in order to generate an output parameter. The output parameter can be the error-reduced image, the semiconductor structure itself or the size parameter. Afterwards, in step S22, the size parameter itself is determined on the basis of the output parameter. The artificial neural network was used here. However, it is also possible to use other machine learning methods in step S21, as explained above.

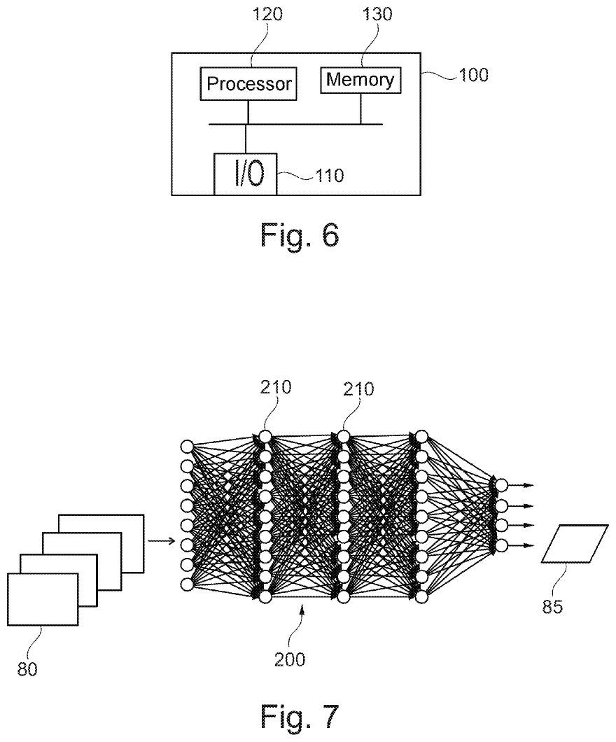

FIG. 6 schematically shows a device configured to carry out the method described above. The device includes an input/output unit 110, by which data can be input into the device and data can respectively be output. The input data of the device can be the error-containing or error-reduced images, for example, wherein the output data can be the size parameter, the noise-reduced image or the semiconductor structure. The device 100 includes a processor unit 120 having one or more processors which can execute control commands stored in a memory unit 130. The memory unit can include additional program modules for execution by the processor unit 120 in order to carry out the method described above. The neural network, for example, which can be embodied as explained above, can be stored in the memory unit 130. However, it is also possible for the neural network to be stored on an external storage unit, for example in a cloud environment. Furthermore, the different functional units 110 to 130 do not have to be present together on one physical unit. They can also be distributed at different locations, in the case of a cloud application.

In summary, the disclosure described above makes it possible to determine a size parameter with the aid of a neural network, as a result of which less expert knowledge is involved in comparison with methods from the prior art.

What is claimed is:

1. A method, comprising:
applying an image of a semiconductor product to a machine-learning-based method which has been trained with training images of semiconductor products to generate an output parameter from the image of the semiconductor product; and
using the output parameter to determine a size parameter of a structure in the semiconductor product,
wherein the image of the semiconductor product was generated by radiating charged particles onto the semiconductor product.

2. The method of claim 1, wherein the image of the semiconductor product is an error-containing image comprising error components created due to the charged particles.

3. The method of claim 1, wherein:
the image of the semiconductor product comprises an error-reduced image of the structure in the semiconductor product; and
in the error-reduced image of the structure in the semiconductor product, error components created due to the charged particles are reduced compared to an image of the structure which comprises error components created due to the charged particles.

4. The method of claim 3, wherein the machine-learning-based method determines the size parameter of the structure in the semiconductor product directly from the image of the semiconductor product.

5. The method of claim 2, wherein the machine-learning-based method determines the size parameter of the structure in the semiconductor product directly from the image of the semiconductor product.

6. The method of claim 1, wherein the machine-learning-based method determines the size parameter of the structure in the semiconductor product directly from the image of the semiconductor product.

7. The method of claim 1, wherein:
from the image of the semiconductor product, the machine-learning-based method determines the structure in the semiconductor, which is substantially independent of the charged particles; and
the size parameter is determined on the basis of the structure in the semiconductor product.

8. The method of claim 1, wherein:
from the image of the semiconductor product, the machine-learning-based method determines an error-reduced image of the structure in the semiconductor product;
error components in the error-reduced image due to the charged particles are reduced compared to the image of the semiconductor product; and
the size parameter of the structure in the semiconductor product is calculated on the basis of the error-reduced image.

9. The method of claim 1, wherein the size parameter of the structure in the semiconductor product comprises at least one member selected from the group consisting of roughness of an edge in the structure in the semiconductor product, a width of an element in the structure in the semiconductor product, a diameter of an opening in the structure in the semiconductor product, and a local critical dimension uniformity of the structure in the semiconductor product.

10. The method of claim 1, wherein:
the training images comprise recorded images of the structure in the semiconductor product in which at least one variable is known as a desired output parameter of the machine-learning-based method in the untrained state; and
the at least one variable comprises at least one member selected from the group consisting of: a magnitude of the size parameter; the structure in the semiconductor product; and an error-reduced image of the structure in the semiconductor product, in which error components due to the charged particles are reduced compared with an original image of the structure in the semiconductor produce which comprises error components due to the charged particles.

11. The method of claim 10, wherein training the machine-learning-based method in the untrained state comprises solving a regression problem.

12. The method of claim 1, wherein:
the training images comprise simulated images of the semiconductor structure in which at least one of the variable is known as a desired output parameter of the machine-learning-based method in the untrained state; and
the at least one variable comprises at least one member selected from the group consisting of: a magnitude of the size parameter; the structure in the semiconductor product; and an error-reduced image of the structure in the semiconductor product, in which error components due to the charged particles are reduced compared to an image which is an error-containing image of the structure in the semiconductor produce which comprises error components due to the charged particles.

13. The method of claim 12, wherein the simulated images are determined with the aid of a Markov Chain Monte Carlo method.

14. The method of claim 13, wherein training the machine-learning-based method in the untrained state comprises solving a regression problem.

15. The method of claim 12, wherein training the machine-learning-based method in the untrained state comprises solving a regression problem.

16. The method of claim 1, wherein the machine-learning-based method comprises an artificial neural network.

17. The method of claim 16, wherein the machine-learning-based method determines the size parameter of the structure in the semiconductor product directly from the image of the semiconductor product.

18. The method of claim 1, further comprising radiating charged particles onto the semiconductor product to generate the image of the semiconductor product.

19. One or more machine-readable hardware storage devices comprising instructions that are executable by one or more processing devices to perform operations comprising the method of claim 1. is 20. A system comprising:
one or more processing devices; and
one or more machine-readable hardware storage devices comprising instructions that are executable by the one or more processing devices to perform the method of claim 1.
